(19) United States
(12) Patent Application Publication
(10) Pub. No.: US 2009/0106639 A1
(43) Pub. Date: Apr. 23, 2009

(54) System and Method for an Extensible Media Player

(75) Inventors: Tomi Blinnikka, San Pablo, CA (US); Atul Suklikar, San Carlos, CA (US); Satish Menon, Sunnyvale, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 11/874,171

(22) Filed: Oct. 17, 2007

(51) Int. Cl. G06F 17/00

(52) U.S. Cl. 715/200

(57) ABSTRACT

In a method and system for creating an extensible media player, a media player application is instantiated on a client system. The media player application receives a data presentation file from a server. The data presentation file includes a playlist of media files and modules associated with each of the media files. The data presentation file is parsed and an instance of the playlist is created. The playlist instance may include playlist items corresponding to the media files of the playlist. Each playlist item may have an associated presentation instance governing presentation aspects of the playlist item. When a playlist item is selected for playback, the corresponding media file is transmitted to the client system. The media file and modules associated with the presentation instance for the playlist item are loaded by the instantiated media player. Once loaded, pre-timeline modules are executed prior to the playing of the selected media file. Additional modules are executed concurrently to the playing of the media file. Subsequent to the playing of the media file, post-timeline modules are executed. Following the presentation of the media file and associated modules, the media player application processes the next selected media file and its associated modules.

### BACKGROUND

1. Field of the Invention

Aspects of the present invention relate generally to a media player, and more particularly, to an extensible media player.

2. Description of Related Art

Current media player solutions found on Internet web pages are designed and written like most computer applications. When a new feature is to be added to the media player, the feature must be written into the main media player application, essentially requiring a full product cycle. This increases the deployment time of the media player.

Current media player solutions also fail to provide a fully dynamic system to program the user experience on-the-fly. While solutions exist to render different visual items based on cue points within the media being played or based on pre-defined criteria, these items are fixed and must be pre-programmed with the media being played.

Thus, it would be desirable to provide a method and system for creating an extensible media player capable of being modified dynamically to provide a highly interactive experience for a user.

### SUMMARY

Embodiments of the present invention overcome the above-mentioned and various other shortcomings of conventional technology, providing a method and system for creating an extensible media player.

In accordance with one aspect, a media player application may be instantiated. The media player application may receive a data presentation file which may include a playlist of media files and modules associated with each of the media files. The data presentation file may be parsed and an instance of the playlist may be created. The playlist instance may include playlist items corresponding to the media files of the playlist. Each playlist item may have an associated presentation instance governing presentation aspects of the playlist item. When a playlist item is selected for playback, the corresponding media file may be transmitted. The instantiated media player application may load the media file and modules associated with the presentation instance for the playlist item. Once loaded, pre-timeline modules may be executed prior to the playing of the selected media file. Additional modules may be executed concurrently to the playing of the media file. Subsequent to the playing of the media file, post-timeline modules may be executed. Following the presentation of the media file and associated modules, the media player application may process the next selected media file and its associated modules.

The foregoing and other aspects of various embodiments of the present invention will be apparent through examination of the following detailed description thereof in conjunction with the accompanying drawing figures.

### BRIEF DESCRIPTION OF THE DRAWING FIGURES

FIG. 1 is a simplified diagram illustrating an embodiment of a system for providing an extensible media player.

FIG. 2 illustrates an embodiment of an extensible media player system.

FIG. 3 illustrates an embodiment of an extensible media player application.

FIG. 4 illustrates an embodiment of an extensible media player application.

FIG. 5 illustrates an embodiment of an extensible media player application.

FIG. 6 illustrates an embodiment of an extensible media player application.

FIG. 7 is a flowchart illustrating one embodiment of a method for providing an extensible media player.

### DETAILED DESCRIPTION

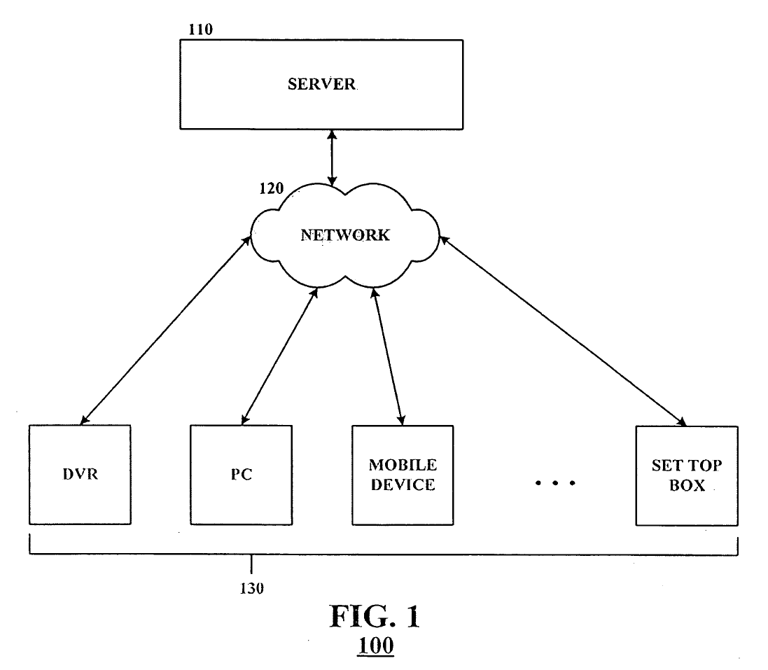

FIG. 1 is a simplified diagram illustrating one embodiment of a system for providing an extensible media player. The system 100 includes one or more servers storing a plurality of media files. The media files may be encoded in any format, including but not limited to the mpeg, avi, wmv, wma, mov, wav, mp3, aau, m4a, m4p, MIDI, and DivX formats. Various other encoding formats may be used advantageously with the embodiments described herein below; differences between these formats are immaterial to the present discussion unless otherwise noted. The servers also may store a player application, which may be passed to a plurality of client devices, and a plurality of modules, each of which may extend a functionality aspect or presentation aspect of the player application. Each module may include visual items, application logic, or a combination of the two. The servers may create and store a presentation data file based on user requests and third party requests, such as requests from content providers and advertisers. The presentation data file also may be created editorially. The presentation data file may be a XML-based file, such as, for example, a Media RSS (MRSS) file with extensions for the player application. The presentation data file may define the media items available to be played by the player application, as well as the player application components (i.e., modules) to be displayed for each media item. The presentation data file also may specify when each module associated with each media item becomes active and inactive, as well as the location of each module in the media player application. The presentation data file may be transmitted to any of the plurality of client devices.

The system also may include a plurality of client devices capable of instantiating or executing a media player application to play a media file, such as a video file or an audio file. The devices may include but are not limited to personal computers, digital video recorders (DVRs) or personal video recorders (PVRs), set top boxes which may receive content through cable, satellite, or Internet Protocol via network infrastructure including but not limited to wireless media and fiber optic cable (e.g., IPTV or Internet television), and mobile devices, such as cell phones, personal digital assistants (PDAs), or other wireless devices capable of playing video files. Each device may include software to process and play media files. The software may comprise a standalone media player capable of playing media files and parsing the presentation data file to execute modules. Alternatively, the software may include an Internet browser or other software in which the media player application, in the form of, for example, a Java applet or Flash-based player, may be instantiated or embedded. A client device may be configured to send a request through a network to the server to access one of the media files presented in the presentation data file. In response to a request from a connected device, a server may stream or transfer the selected media file(s) and accompanying modules associated with the selected media file over a network to the requesting device.

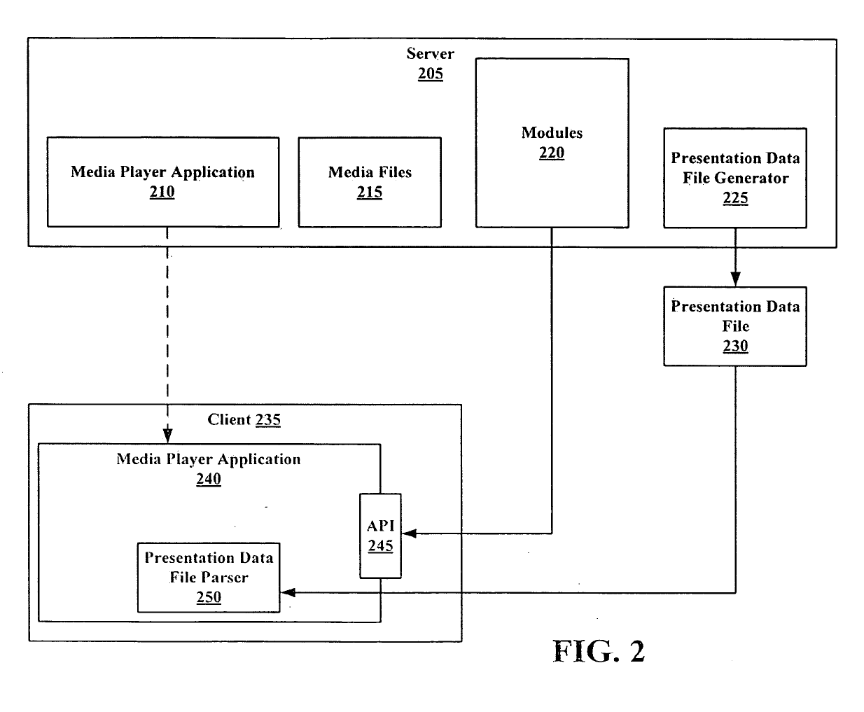

FIG. 2 illustrates an embodiment of a system for providing an extensible media player. The system may include a server 205 connected, in one embodiment, through a wired or wireless network, to a client device 235, such as a personal computer or portable communications device (e.g., a wireless telephone or Personal Digital Assistant (PDA)). The server 205 may store a media player application 210 or software code for implementing or instantiating a media player application on the client device 235, one or more media files 215, and one or more modules 220. The server 205 also may store presentation data files or include a presentation data file generator 225 which generates presentation data files.

The media files 215 may have any video or audio or mixed video/audio format, including but not limited to the types mentioned earlier. The particular format of the media files 215 stored in the server 205 is immaterial for the purposes of the present discussion, unless otherwise noted. The media files need not be stored in only one server, and may be stored in multiple servers. The one or more modules may provide additional player functionality or presentation features for the media player application. Examples of modules may include but are not limited to a player controls module, a playlist module to display available media files, a pre-timeline curtain module to display an advertisement prior to a media file, a banner to display a presentation aspect during playing of a media file, a post-roll curtain to display a presentation aspect subsequent to the playing of a media file, and a container to display third party content. Generally, modules may be designed and stored to interface with the media player application prior to, during, or subsequent to the playback of a media file. The modules may control an aspect of the playback of media files or may affect an aspect of the presentation of the media player application to a user.

The modules related to presentation aspects of the media player application may either transparently overlay or fully obscure part or all of the media file being played. Each module may have a default aspect ratio of 4:3, but may have logic necessary to conform to other aspect ratios, such as 16:9. Each module also may be resizable to any size. The modules may be configured to retrieve additional data from remote sources, such as the server, if needed, or to record and transmit usage information to the remote source. For example, if a closed captioning module is associated with a media file, the closed captioning module may retrieve the closed captioning data from a remote source to present to a user. The modules 220 also may be interactive, thereby enabling the user to control presentation of the media file or to access additional related content presented to the user before, during, or after presentation of the media file. In one embodiment, the media player application 240 and the modules 220 may be Flash-based components conforming to a specific version of Flash, including but not limited to, Flash 9. The container module may enable non-Flash third party content or third party content not conforming to a specific version of Flash to be displayed in conjunction with the media file being played in the media player application.

The presentation data files, either stored in the server 205 or generated by the presentation data file generator 225, may define a set of available media files to be played (i.e., a playlist) as well as media player application components 220 (i.e., modules) to be executed or displayed for each media item of the playlist. The presentation data file may further define the modules 220 by defining the ordering and timing of the modules 220 for a given media file (i.e., when a module is active and inactive). The timing of the modules 220 may be expressed as a function of time, events, or elapsed frames of the media file with which the module is associated. For modules 220 relating to the presentation of the media file to a user, the presentation data file also may specify the location and placement of the module within the media player application. The presentation data file may be a XML-based file such as a Media RSS (MRSS) file. Alternatively, the presentation data file may be a binary file. As a binary file may have a smaller file size than other file formats, the length of time to download a binary presentation data file may decrease, thereby improving performance of the system. A sample presentation data file is shown below:

```
<rss version=“2.0” xmlns:media=http://search.yahoo.com/mrss
      xmlns:yemp=“http://schemas.yahoo.com/yemp/”>
  <channel>
      <!-- Modules that are used for all items -->
      <yemp:module start=“0”
source=“http://server.yahoo.com/yemp/modules/PlayerControls.swf”
    zIndex=“9000” />
      <item>
          <yemp:module start=“before”
    source=“http://server.yahoo.com/yemp/modules/StartFrame.swf”
parameters=“src=http://server.yahoo.com/yemp/temp/
SampleThumbnail.jpg”
    zIndex=“9000” />
        <media:content
            url=“http://server.corp.yahoo.com/yemp/temp/test.flv”
            type=“video/x-flv”>
          <media:title>A ye olde TV Tuning</media:title>
          <media:description>TV tuning video
clip</media:description>
          <media:thumbnail
            url=“http://i.imdb.com/Photos/Mptv/1388/th-
5746_0077.jpg”
            height=“50” width=“75” />
        </media:content>
      <yemp:module start=“after”
    source=“http://server.yahoo.com/yemp/modules/PostRoll.swf”
      </item>
  </channel>
</rss>
```

The presentation data file may enable presentation aspects and application logic to be dynamically changed for a media file. For instance, the above sample presentation data file includes a player controls module, a start frame module, and a post-roll module. However, different modules may be substituted on-the-fly by modifying the presentation data file to call other modules. The placement or timing of the modules may be dynamically modified by changing the specifications for the various modules listed in the presentation data file, such as the “height,” “width,” and “module start” parameters.

The client device may execute a standalone media player application 240 or instantiate a media player application 240, within, for instance, an Internet browser. In one embodiment, the media player application 240 may be a Flash-based application. In one embodiment, the media player application 240 may be created as a Microsoft Silverlight™ application capable of playing WMV and WMA media files. The media player application 240 may serve as a platform for the extensible media player, and may include an Application Programming Interface (API) 245 which communicates with the various modules. In this respect, the API 245 may enable the modules 220 to interface with the player application 240 and control the presentation and playback aspects of the player application 240. In one embodiment, the player application API 245 may be public, thereby enabling distributed development of modules.

The presentation data file may be passed to the media player application from within a web page as a parameter or programmatically via JavaScript if the media player application is embedded on a web page. Alternatively, the presentation data file may be retrieved from the network by the media player application if the media player application is given or has knowledge of the source address of the presentation data file. A presentation data file parser 250 may parse the presentation data file 230 to reveal a playlist of media files available for playback. In one embodiment, the presentation data file parser 250 may be integrated into the media player application 240. In one embodiment, the playlist may list a set of FLV videos. An instance of the playlist may be passed to the instantiated or executed media player application, which may further parse the playlist to identify playlist items corresponding to available media files. Each playlist item may have a presentation instance that identifies the modules associated with the playlist item. The playlist items on the playlist may each include an address or link to the location where a corresponding media file 215 is stored. In response to the selection of a playlist item from the playlist, the player application 240 may transmit a request to the server 205 to download or stream the selected media file 215. While the embodiment discussed herein may identify a single server storing media files and modules, it is contemplated that multiple servers may be employed to store modules, media files, and, if the application is instantiated on a client device, an application SWF file. The present invention is not intended to be limited with respect to the number of servers employed, and it is conceivable that each component or aspect of the extensible media player may originate from or be located in a different location. Modules 220 associated with the selected media file also may be downloaded. In one embodiment, the modules 220 may be downloaded separately. Alternatively, the modules 220 may be packaged as one file at the server and downloaded to the client, thereby minimizing network traffic. Packaging the modules as one file may also reduce the load time of the modules, thereby improving the user viewing experience. The media player application 240 may load the selected media file 215 and the downloaded modules 245 for playback and presentation to the user.

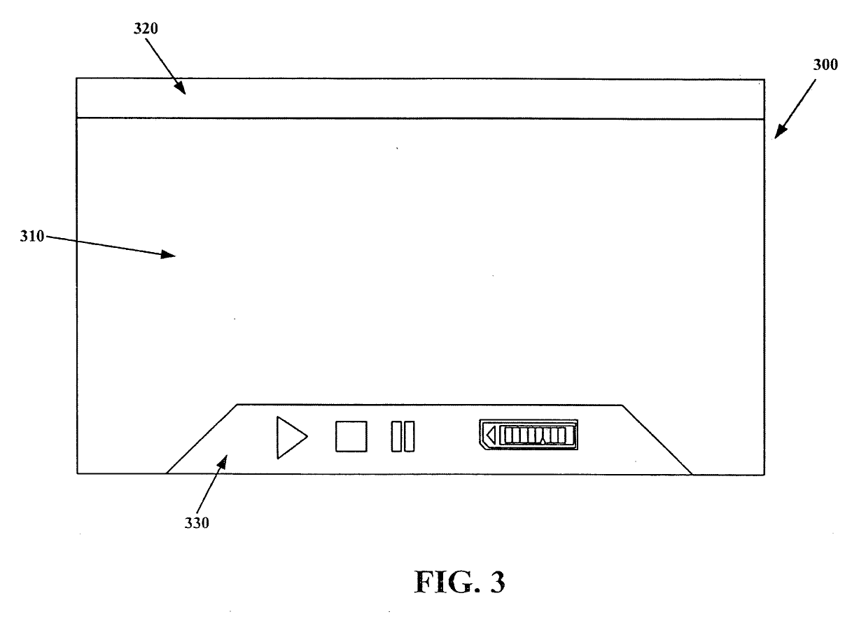

FIG. 3 illustrates an embodiment of an extensible media player. The media player application 300 may be instantiated in a client device, in, for instance, an Internet browser, or may function as a standalone media player application. The media player application 300 may be a Flash-based application. The media player application 300 may include a viewing screen 310 for displaying a selected media file. One or more modules associated with the selected media file may be downloaded and displayed prior to, concurrently with, or subsequent to the playing of the media file. In this embodiment, a banner module 320 may obscure the top portion of the video screen 310. The banner module 320 may display a banner advertisement concurrent to the playing of the selected media file. The placement and shape of the banner module 320 are not fixed; the banner module 320 may be placed anywhere in the video screen 310. In this embodiment, a player controls module 330 may transparently overlay the video screen 310 at the bottom of the video screen 310. The player controls module 330 may permit a user to control the playing of the selected media file. In this embodiment, the player controls module 330 may include a play button, a stop button, a pause button, and a volume adjustment control, but the player controls module 330 need not be limited to these controls and may include additional user controls.

In the event one or more of the modules fail to download or load properly, the instantiated or executed media player application 300 may nevertheless continue to operate without the failed module(s). As the modules provide additional functionality or presentation to the media player application, at a basic minimum, the extensible media player 300 may play the selected media file absent any of the modules, should the modules fail to download or load properly.

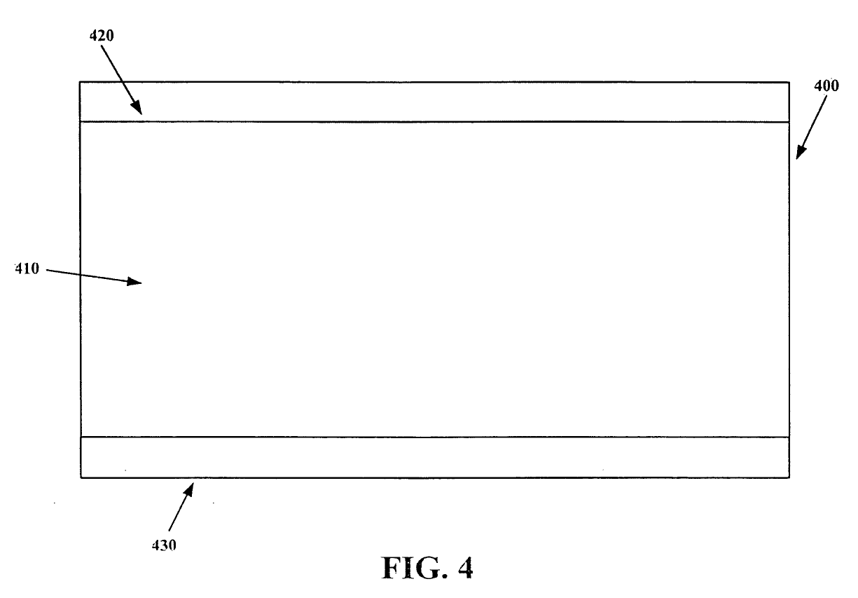

FIG. 4 illustrates an embodiment of an extensible media player. In this embodiment, a media player application 400, either instantiated or executed, may have loaded a selected media file and associated modules. One of the associated modules may be a pre-roll curtain module. The pre-roll curtain module may display an advertisement or other content prior to the playing of the selected media file. In this embodiment, an advertisement may be displayed in the video viewing screen 410. The pre-roll curtain module may include one or more banners 420, 430 which specify identifying information, such as the source of the advertisement displayed and the provider of the media file to be played. The duration of the pre-roll curtain module may be defined by the presentation data file. This duration is dynamic and may differ depending on, among other things, the media file presented or requirements specified by the advertiser.

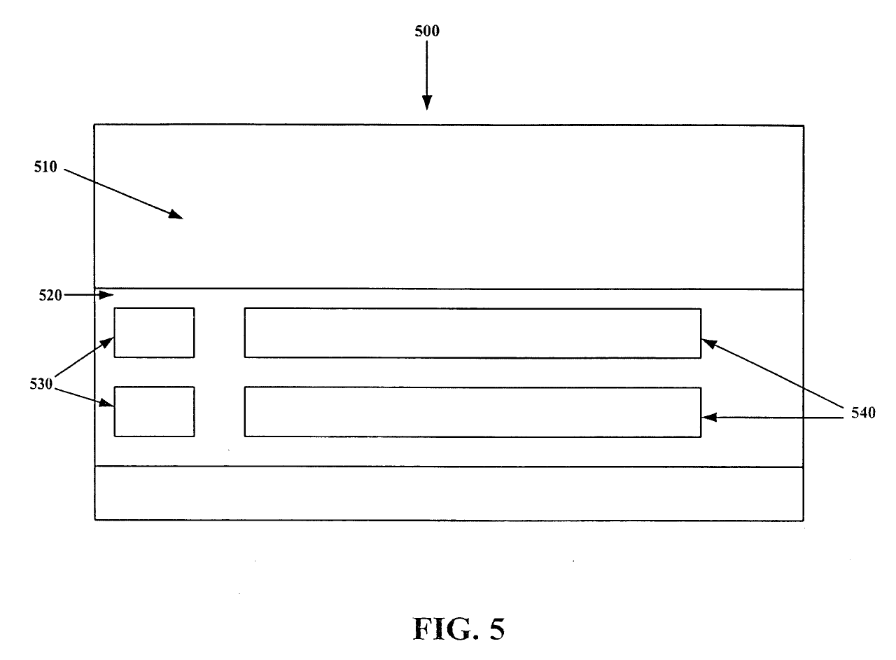

FIG. 5 illustrates an embodiment of an extensible media player. In this embodiment, a media player application 500, either instantiated or executed, and housed in a client device may load and play a selected media file in a video viewing screen 510. Accompanying the loading and playing of the selected media file may be selected modules, downloaded from a server and defined by a presentation data file transmitted from the server to the client device. One of the modules may be a clip list module 520 listing additional media files available for playback. The clip list module 520 may either transparently overlay or fully obscure part or all of the video viewing screen 510. The clip list module 520 may be interactive with the user, enabling the user to select a displayed clip for playback. In one embodiment, the clip list module may be displayed subsequent to the playing of a selected media file. Generally, the timing of execution of the clip list module 520 and other modules is defined in the presentation data file which is parsed and passed to the media player application 500. The clip list module may include one or more thumbnail preview images 530 and accompanying captions 540 describing the subject matter of the media files.

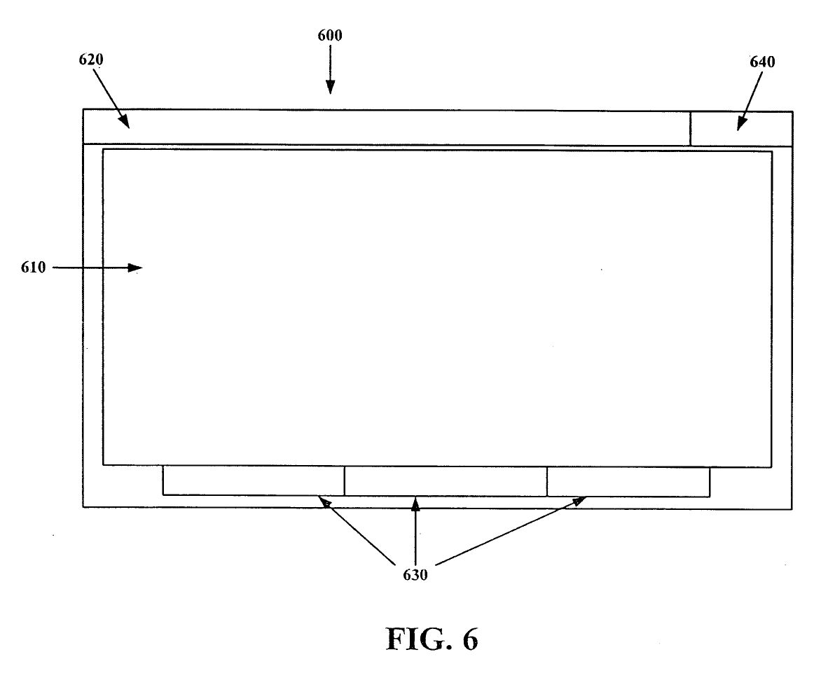

FIG. 6 illustrates an embodiment of an extensible media player. The extensible media player application may be configured to display rich media advertisements, which display an advertisement to a user and enable the user to interact with the advertisement. A rich media advertisement may be displayed any time prior to, concurrent with, or subsequent to the playing of a selected media file. The advertisement may be displayed when a video is paused or otherwise halted. The timing of the rich media advertisement may be defined by the presentation data file passed from the server to the client. In this embodiment, the rich media advertisement may include an advertisement displayed in a video viewing screen 610, accompanied by a banner 620 identifying the source of the advertisement, interactive banners 630 enabling a user to obtain additional information about the advertisement, and an exit button 640 enabling a user to close or exit from the advertisement. The duration and placement of these presentation aspects is not fixed and may be specified in the data presentation file. The interactive banners 630 may be configured to communicate with remote sources for retrieval of additional information related to the advertisement. In response to the selection of one of the interactive banners 630, the banners 630 may open additional browser windows and/or direct the user to a related content.

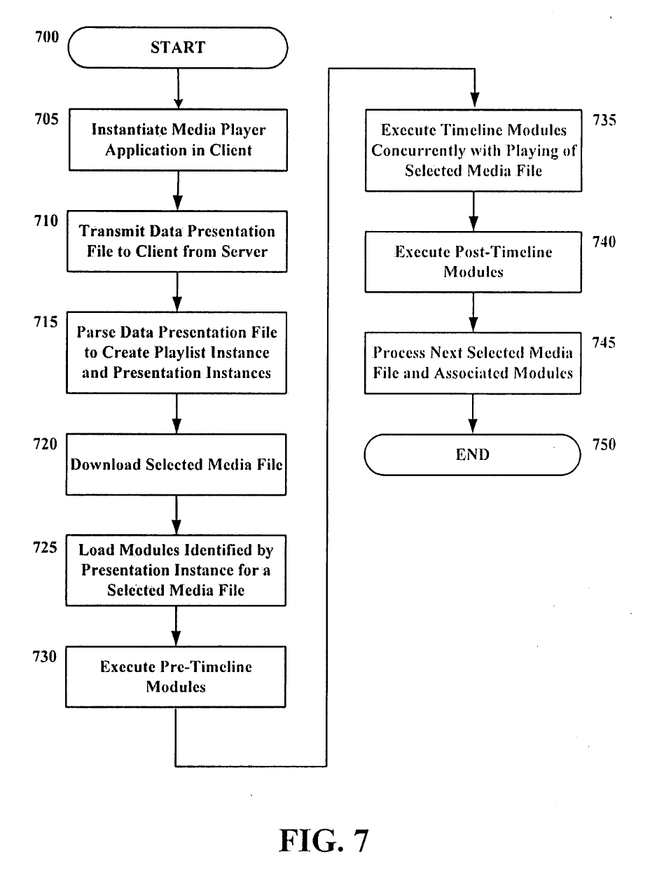

FIG. 7 is a flowchart illustrating one embodiment of a method for providing an extensible media player. In block 705, a media player application may be instantiated in a client device. In one embodiment, the media player application may be a Flash application embedded in a web page in an Internet browser. Alternatively, the media player application may be created as a Microsoft Silverlight™ application. In block 710, a presentation data file may be transmitted to the client device from the server. The presentation data file may be passed to the media player application from within a web page as a parameter or programmatically via JavaScript if the media player application is embedded in the web page. Alternatively, the media player application instantiated or residing in the client device may be given the source address of the presentation data file in order to fetch the presentation data file from a remote source in a network. The presentation data file may define a set of media files available for playback. Additionally, the presentation data file may specify one or more modules associated with each of the defined media files. These modules may affect an aspect of the presentation of a media file to a user or may extend the functionality of the media player application. The modules may control the presentation, playback, and other aspects of the media player through interaction with an API of the media player application. The presentation data file may specify presentation parameters for the modules affecting presentation aspects of the media file, such as, for example, the height, width, aspect ratio, transparency, and duration of the modules for a particular media file.

In block 715, the presentation data file may be parsed, and an instance of a playlist document may be passed to the media player application. The playlist instance may include a playlist items corresponding to media files available for playback. Each playlist item listed in the playlist may include an address or location from which a corresponding media file may be retrieved. A presentation instance may be created for playlist item listed in the playlist instance. The presentation instance may specify which modules and module-specific parameters are to be used by the media player application for a specific media file. In block 720, in response to a user selection of a playlist item, the media player application may request that a server transmit the requested media file corresponding to the playlist item to the client device. The server may transfer or stream the requested media file. In block 725, the media player application may load the downloaded or streamed media file and specified modules associated with the selected media file. The modules may be downloaded from URLs specified in the presentation data file. Version checking for each module may be performed using the module URL.

In block 730, pre-timeline modules, defined to be executed and/or displayed prior to the playing of the selected media file, may be executed. Examples of pre-timeline modules may include but are not limited to a pre-roll curtain displaying an advertisement, and a container module to house third party content which may conflict or be non-conforming with the media player application. In block 735, the media player application may load and play the selected media file. The media player application also may execute and/or display modules chosen to concurrently run with the playing of the media file. Such modules may include but are not limited to a banner module to display an advertisement during playing of the media file, a player controls module to display a set of user controls for controlling the playing of the media file, a closed captioning module to display closed captioning, and a clip list module to offer additional available media files for playback. In block 740, subsequent to the playing of the media file, the media player application may execute and/or display post-timeline modules. Post-timeline modules may include but are not limited to the clip list module and a post-roll curtain module to display an advertisement subsequent to the playing of the media file. In block 745, the media player application may process the next playlist item selected by a user. Processing may include downloading or streaming the media file, downloading associated modules, and loading the media file for the next playlist item and associated modules.

Those of skill in the art will appreciate that an extensible media player may be enabled to facilitate the deployment of a multi-layered dynamic media player system. Such a system may be implemented and deployed without the delay of a traditional product cycle. The dynamic nature of the extensible media player allows for the media player application to be modified based on changing business needs and on a per view or per user basis. The present disclosure is not intended to be limited with respect to the type of device capable of implementing the extensible media player. Moreover, the present disclosure is not intended to be limited with respect to the modules disclosed herein. Additional modules may be employed to add functionality to the media player application or to control an aspect of the presentation of a media file played in the media player application.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. An extensible media player, comprising:
a media player application to load a playlist of multimedia files and play a selected multimedia file from the playlist;
a plurality of modules, each module containing application logic to extend functionality of said media player application or to control a presentation aspect of the multimedia file playback;
a data presentation file to identify the playlist of multimedia files and, for each of the multimedia files, at least one module associated with each of the multimedia files,
wherein, said media player application parses said data presentation file, loads the at least one module associated with the selected multimedia file based on the parsing, and executes the at least one module in an order and location identified by said data presentation file.

2. The extensible media player of claim 1, wherein the at least one module is bundled into a package, the package enabling a single download from a server.

3. The extensible media player of claim 1, wherein said plurality of modules extend the functionality of said media player application or control the presentation aspect of the multimedia file playback through an application programming interface of said media player application.

4. The extensible media player of claim 1, wherein said data presentation file identifies a starting point for activating each of the at least one module and an ending point for de-activating each of the at least one module.

5. The extensible media player of claim 4, wherein the starting point and the ending point are expressed as a function of time, an application event, or elapsed frames of the selected multimedia file.

6. The extensible media player of claim 1, wherein said media player application is a Flash application, the multimedia files are FLV files, and said presentation data file is a XML-based file.

7. The extensible media player of claim 1, wherein each of said plurality of modules is configured to communicate with each other and a server.

8. The extensible media player of claim 7, wherein each of said plurality of modules is configured to retrieve content relating to the functionality or the presentation aspect from the server and to report usage information to the server.

9. A method, comprising:
instantiating a multimedia player application on a client system;
transmitting to the client system a data presentation file from a server, the data presentation file including a playlist of multimedia files and modules associated with each multimedia file of the playlist, wherein the modules extend functionality of the instantiated multimedia player application or control a presentation aspect of the instantiated multimedia player application during a multimedia file playback;
parsing the data presentation file to create an instance of the playlist, the instance of the playlist containing playlist items corresponding to each of the multimedia files on the playlist, wherein a presentation instance is created for each playlist item;
responsive to a selected playlist item, transmitting to the client system a corresponding multimedia file;
responsive to said transmitting, loading, in the instantiated multimedia player application, the corresponding multimedia file and a set of modules identified by the presentation instance for the selected playlist item;
executing pre-timeline modules from the set of modules to be presented by the instantiated multimedia player application prior to playing the selected multimedia file, wherein the data presentation file specifies an order and location of the executed pre-timeline modules;
while the selected multimedia file is played by the instantiated multimedia player application, executing timeline modules to be presented during playing of the selected multimedia file, wherein the data presentation file specifies an order and location of the executed timeline modules;
subsequent to the playing of the selected multimedia file, executing post-timeline modules to be presented, wherein the data presentation file specifies an order and location of the executed post-timeline modules; and
processing a next selected playlist item from the instantiated playlist and associated set of modules identified by a corresponding presentation instance.

10. The method of claim 9, further comprising, at the server, packaging the set of modules for the presentation instance of the selected playlist item into a package, wherein the package is transmitted to the client system.

11. The method of claim 9, wherein the modules extend the functionality of the instantiated multimedia player application or control the presentation aspect of the instantiated multimedia player application through an application programming interface of the instantiated multimedia player application.

12. The method of claim 11, wherein each of the modules is re-sizeable.

13. The method of claim 9, wherein the data presentation file identifies a starting point for activation of each of the at least one module and an ending point for de-activating each of the at least one module.

14. The method of claim 13, wherein the starting point and the ending point are expressed as a function of time, an application event, or elapsed frames of the selected multimedia file.

15. The method of claim 9, wherein each of the modules is configured to communicate with other modules and the server.

16. The method of claim 15, wherein the each of the modules is further configured to retrieve content relating to the presentation aspect from the server and to report usage information to the server.

17. A computer-readable storage medium storing instructions capable of being executed by a processor to perform the method of claim 9.

18. A multimedia presentation system, comprising:
a server, storing multimedia files, presentation modules, and a data presentation file; and
a client, configured to communicate with said server, comprising a processing unit and a memory unit, said memory unit storing instructions adapted to be executed by the processing unit to:
instantiate a multimedia player application on a client system;
transmit to the client system a data presentation file from a server, the data presentation file including a playlist of multimedia files and modules associated with each multimedia file of the playlist, wherein the modules extend the functionality of the instantiated multimedia player application or control a presentation aspect of the instantiated multimedia player application during a multimedia file playback;
parse the data presentation file to create an instance of the playlist, the instance of the playlist containing playlist items corresponding to each of the multimedia files on the playlist, wherein a presentation instance is created for each playlist item;
responsive to a selected playlist item, transmit to the client system a corresponding multimedia file;
responsive to said transmitting, load, in the instantiated multimedia player application, the corresponding multimedia file and a set of modules identified by the presentation instance for the selected playlist item;
execute pre-timeline modules from the set of modules to be presented by the instantiated multimedia player application prior to playing the selected multimedia file, wherein the data presentation file specifies an order and location of the executed pre-roll modules;
while the selected multimedia file is played by the instantiated multimedia player application, execute timeline modules to be presented during playing of the selected multimedia file, wherein the data presentation file specifies an order and location of the executed timeline modules;
subsequent to the playing of the selected multimedia file, execute post-timeline modules to be presented, wherein the data presentation file specifies an order and location of the executed post-timeline modules; and
process a next selected playlist item from the instantiated playlist and associated set of modules identified by a corresponding presentation instance.

19. The system of claim 18, wherein the set of modules is bundled into a package, the package enabling a single download from a server.

20. The system of claim 18, wherein the modules extend the functionality of the instantiated multimedia player application or control a presentation aspect of the instantiated multimedia player application through an application programming interface of the instantiated multimedia player application.

21. The system of claim 20, wherein each of the modules is re-sizeable.

22. The system of claim 18, wherein the data presentation file identifies a starting point for activation of each of the modules and an ending point for de-activating each of the modules.

23. The system of claim 22, wherein the starting point and the ending point are expressed as a function of time, an application event, or elapsed frames of the selected multimedia file.

24. The system of claim 18, wherein each of the modules is configured to communicate with other modules and the server.

25. The system of claim 24, wherein the each of the modules is further configured to retrieve content relating to the functionality or the presentation aspect from the server and to report usage information to the server.
